(19) United States
(12) Patent Application Publication
(10) Pub. No.: US 2009/0034271 A1
(43) Pub. Date: Feb. 5, 2009

(54) Light fixture

(76) Inventors: Markus Gorres, Dortmund (DE); Matthias Bremerich, Lennestadt (DE)

Correspondence Address: K.F. ROSS P.C., 5683 RIVERDALE AVENUE, SUITE 203 BOX 900, BRONX, NY, 10471-0900, US

(21) Appl. No.: 11/888,629

(22) Filed: Aug. 1, 2007

(51) Int. Cl. F21V 7/04; B23P 17/04

(52) U.S. Cl. 362/346; 29/592

(57) ABSTRACT

A light fixture (10) is described and shown. Its uniqueness is comprised inter alia in that facet-like undercut segments (14a, 14b, 14c, 14d, 14e, 14f, 14g, 14h, 14i, 14j, 14k, 14l, 14m, 14n) are arranged on the interior (30) of a cup-shaped curved reflector (21).

The invention relates to a light fixture for illuminating building surfaces or portions thereof or exterior surfaces in accordance with the preamble to claim 1.

A light fixture in accordance with the preamble of claim 1 is based on applicant's German patent application DE 10 2004 042 915 A1.

The known light fixture has a reflector that has numerous facet-like segments in its interior. Each segment has a surface that is inwardly concavely arcuate and that can have a spherical, cylindrical, or nonspherical basic shape.

A reflector described in DE 199 10 192 A1 serves for reflecting light beams and also has a plurality of internal facet-like segments.

Proceeding from the above-described light fixture, the object of the invention consists of further developing a light fixture in accordance with the preamble to claim 1 such that it is better able to control illumination intensity distribution.

The invention attains this object with the features of claim 1, in particular with those in the characterizing portion, and is consequently characterized in that radial undercuts (HL, HM, HN) relative to the center longitudinal axis are provided in at least some of the segments.

The principle of the invention is thus essentially comprised in providing radial undercuts relative to the center longitudinal axis. This means that the inside of the reflector or reflector element is shaped such that there are undercut or dead regions at least between individual segments. Viewing the reflector element along its center longitudinal axis, that is, viewed along the center longitudinal axis inside the reflector, it is not possible to see the undercuts or dead spaces. These are true radial undercuts.

These radial undercuts enable a particular shape, curvature, arching, or positioning of the segments. For instance, cylindrical segments can be positioned in a particular manner in order to thus enable a particularly uniform illumination intensity distribution, or an illumination intensity distribution that is oriented at a certain solid angle. The radial undercuts can be especially advantageous even when non-cylindrical segments are used, for instance when spherical or nonspherical segments with any curvature radii are used along different cross-sections of the segments.

The inventive teaching enables a special inner shape of a reflector in a light fixture that can be configured in an entirely freely selectable manner. In particular, light radiated from the light source and striking the reflector can now be radiated passing relatively close to the edge of the reflector. If the light fixture is mounted on the ceiling, for instance, in this manner side walls of a building space can be illuminated far upward.

The inventive light fixture preferably has a reflector made of aluminum. More advantageously the reflector is made of swaged aluminum. The use of aluminum as a material for the reflector element offers a number of advantages. On the one hand conventional materials and machining processes can be used. On the other hand, aluminum offers a particularly high-quality surface, in particular in terms of light engineering, having a highly efficient reflecting surface. Moreover, the reflector element can be produced inexpensively and is very light.

on the other hand, an inventive light fixture cannot be produced using conventional steps since, due to the inventively arranged radial undercuts, it cannot be removed from the die axially. An inventive novel manufacturing method and an inventive novel tool and die are needed. This is described later.

The formulation according to which the reflector has a center longitudinal axis relates in particular to mainly rotationally symmetrical reflectors. Rotationally symmetrical reflectors are those that are arranged rotationally symmetrical about the center longitudinal axis in terms of their basic shape, that is, in terms of their cup shape. The basic shape is also rotationally symmetrical when segments are arranged about the center longitudinal axis in a non-rotationally symmetrical manner.

There is also a center longitudinal axis of a reflector in a reflector having for example a square cross-section. Essentially the reflector axis that extends from an apex of the reflector to its light outlet aperture is called the center longitudinal axis of the reflector.

The formulation according to which in accordance with the invention radial undercuts are provided in at least some of the segments signifies that at least one segment that is arranged closer to one edge of the reflector projects beyond or overlaps an adjacent segment that is arranged closer to the apex, the overlapping or projecting region being concave. When viewed along the center longitudinal axis from the light outlet apertures of the reflector to the apex this radial overlapping region forms a dead space or shadow space.

The inventive light fixture illuminates building surfaces or portions thereof or exterior surfaces. In particular the inventive light fixture provides illumination, in particular especially uniform illumination, of floor surfaces and/or wall surfaces and/or ceiling surfaces of a building. When the inventive light fixture is made as an exterior light fixture, paths, lawns, and parking lots can also be illuminated, for instance. The inventive light fixture also illuminates objects, for instance pictures or statues.

It includes a mainly cup-shaped curved reflector, in particular a parabola reflector, that is, a reflector that has a mainly parabolic cross-section. Further advantageously, in terms of its basic shape the reflector is made mainly rotationally symmetrical about its center longitudinal axis.

A light source can be arranged inside the reflector. It can be for instance a HIT light fixture, e.g. a HIT-TC-CE lamp, or another halogen metal vapor lamp, or alternatively it can be one or a plurality of LEDs. Also, a plurality of HIT lamps can be arranged inside the reflector. Advantageously, only one lamp is inserted into the inside of the reflector through an opening in the reflector, in particular through an opening placed in the apex of the reflector. In addition to using HIT lamps, low-voltage halogen lamps can also be employed, for instance QT9, QT12, and QT16 light emitter. Preferably in particular mainly point sources of light are used, i.e. those light emitter that emit the light from a particularly small volume.

A plurality of facet-like segments are arranged on the interior of the reflector. The interior of the reflector can be completely filled with facet-like segments or can be only partially filled with segments, i.e. along certain partial regions. For instance, it is conceivable that only one circumferential angle of e.g. 90°, that is, a segment that is one quarter of a circle, is filled with facet-like segments, and the other three-quarters of the reflector is mainly smooth.

Each segment has a surface that arches toward the inside. Preferably at least some of the segments have a reflecting surface with a cylindrical basic shape. This means that the segments are provided by a body that originates as a sectional body of a cylindrical body, in particular a circular cylinder.

Alternatively, at least some of the segments have a reflecting surface having a spherical or nonspherical basic shape. This means that the segments are provided by a body that originates as a sectional body of a spherical body or a rotational ellipsoid or a body that is arced differently along different sectional planes.

If there are cylindrical segments, one cylinder axis can be provided in each cylindrical segment. The cylinder axis is the center longitudinal axis for the cylindrical base body or is parallel thereto. Each cylinder is preferably a circular cylindrical body.

The reflecting surface of the segment is that surface section of the segment that contributes to the reflection of light beams that are emitted from the light source. In a cylindrical segment, the reflecting surface is arced around the center longitudinal axis of the cylindrical basic body.

In the context of this patent application, each axis that runs parallel to the center longitudinal axis of the cylindrical segment is termed a cylinder axis of the cylindrical segment.

A plurality of cylindrical segments are advantageously arranged between the apex of the reflector and a free edge of the reflector. These cylindrical segments can be arranged immediately adjacent one another, and in this manner can transition into one another, e.g. in a step-like manner or in a sawtooth manner. It is also possible for two cylindrical segments to be arranged spaced apart from one another, there being between the cylindrical segments that are arranged apart from one another a flat or smooth surface or a segment with a different, non-cylindrical arch.

In the inventive light fixture, the cylinder axes are advantageously oriented at an acute angle, that is, an angle that is less than 90°, to the center longitudinal axis of the reflector. The cylindrical segments are thus arranged such that their cylinder axis intersects the center longitudinal axis of the reflector at an acute angle. The orientation of the cylinder axes relative to the center longitudinal axes of the reflector advantageously varies in the different segments with a different distance from the apex of the reflector.

A connecting region is provided in each cylindrical segment. The region of the segment with which the segment is connected to the reflector is called the connecting region of the segment. It can be the head region of the cylindrical segment, for instance, that is, the region of the cylindrical segment that is adjacent the apex of the reflector, or alternatively a lateral region of the cylindrical segment. The connecting region of a segment is preferably that region of a segment that is adjacent the reflector. A tangent can be placed on the exterior of the reflector in each connecting region of a segment. The outside face of the reflector is understood to be the face of the reflector that faces away from the inside. It is assumed that the outside face of is the reflector is not structured and that the reflector has only a very thin wall thickness. If the exterior of the reflector is structured, the tangent is applied to an imaginary curve, e.g. to a parabola, that defines the basic shape of the reflector.

An angle of deviation is preferably formed between the tangent and the cylinder axis of the associated segment. This angle of deviation is preferably an acute angle and varies with the distance between the segment and the apex of the reflector.

Expressed differently, the cylindrical segments are arranged and oriented such that, when viewing a cross-section through the reflector, the longitudinal sides, that is the surfaces, of the cylinder that contribute to optical light deflection are oriented such that they form a polygonal structure that deviates from the basic shape of the reflector.

In this manner a reflector with an elliptical basic shape can be imitated for instance by using a mainly parabolically arced reflector and by appropriately positioning the cylindrical facets. This enables for instance a small structural shape for the reflector compared to a reflector with an elliptical cross-section and correspondingly enables the design of a light fixture having only a shallow installation depth.

On the other hand, an illumination intensity distribution that is nearly anything desired is generated by positioning the cylindrical facets in accordance with the inventive teaching using radial undercuts. For instance, it is possible for an illumination intensity distribution to be attained inside a given light field that is completely uniform. Alternatively, in the case of using the light fixture for illuminating floors and side walls, e.g. of a building room, the side wall can be particularly uniformly illuminated. This is attained in that light is reflected to an upper side wall.

The use of facets with a cylindrical, reflecting surface enables particularly uniform illumination intensity distribution and the production of “white light,” since beam bundles are spread by striking the cylindrically arced surface. At the same time, the use of cylindrical segments with different angles of deviation makes it possible to influence the illumination intensity distribution in the desired manner. The arrangement of undercuts makes it possible to radiate light, in particular even in very high room regions.

The advantageous arrangement of cylindrical facets such that the angle of deviation varies with the different distance from the segment to the apex of the reflector enables upward and downward deflection of some light. The terms “upward” and “downward” refer to a ceiling arrangement of the reflector and relate to a cross-sectional view of the reflector. Expressed differently, using the different angles of deviation, light can be deflected in a desired manner into the segments at desired angles with respect to the center longitudinal axis of the reflector. Thus the illumination intensity distribution varies especially advantageously in the desired manner.

The size of the undercuts, that is for instance also the amount of radial overlap, but also the height of the undercut relative to the center longitudinal axis, can vary. Thus, the size of the undercut can vary both angularly of the reflector and also in the direction of the center longitudinal axis, that is, precisely, in a direction along the basic shape of the reflector between the edge and apex of the reflector, that is, along a column of segments. The variation in the undercuts depends on the desired illumination intensity distribution that is to be produced.

In accordance with another advantageous embodiment of the invention, light source is a point. This is a light source that is made mainly as point light sources, i.e. only emits light from a very small volume. Metal-vapor halogen lamps, e.g. a HIT-TC-CE lamp, QT lamps as low-voltage halogen lamps, or at least one LED lamp are advantageously used for light sources. Naturally a plurality of light emitter or a group of light emitter can also be arranged in the inside of the reflector, preferably near the focal point of the reflector or in the focal point of the reflector. On the one hand, this makes possible a particularly illumination intensity distribution that can be determined in advance, and on the other hand it enables high light current.

In accordance with another advantageous embodiment of the invention, the reflector has a mainly parabolic cross-section. The reflector is consequently made as a parabolic reflector. It is advantageously mainly rotationally symmetrical in terms of its basic shape. This means that, without taking into account any non-symmetrically arranged segments, the cup shape of the reflector is formed by a body that is mainly rotationally symmetrical about the center longitudinal axis of the reflector.

The reflector consequently advantageously has a mainly circular light outlet aperture. The reflector is attached to the light fixture, it being possible to overlap the free edge of the reflector for instance by a part of the housing for the light fixture and/or by a fastening means, e.g. a screw. If the light fixture is a ceiling can light or downlight, the free edge of the reflector can terminate for instance flush with the ceiling surface.

In accordance with one advantageous embodiment of the invention, the curvature radii of the segments vary along a row. A row is a circular arrangement of segments about the center longitudinal axis of the reflector. If the segments are arranged along the entire inner surface of the reflector, the rows, or at least some of the rows, can be closed. If the segments are arranged only along a circumferential angle of the inner surface of the reflector, the rows can also extend only across a circumferential angle of the inner surface of the reflector.

When using rotationally symmetrical reflectors and mainly point light sources, the curvature radii of the segments along a row can produce illumination intensity distributions that deviate from a rotational symmetry. For instance, mainly oval illumination intensity distributions can be generated that are particularly suitable for instance for illuminating parking regions or for using the light fixture as a sculpture spot, i.e. for illuminating sculptures or similar objects.

The light fixture can also be arranged directly on a ceiling of a building and made as a downlight. Alternatively, the light fixture can be affixed to a ceiling of a building room indirectly via conductor rails. In each of the two above-described applications the light fixture can illuminate the region of a side wall of a building room and simultaneously the region of a floor of a room. If only a side wall of a room and a section of a floor surface are to be illuminated, the curvature radii of the segments vary along a row for instance such that e.g. a quarter circle segment of the inner surface of the reflector is filled with cylindrical facets that have a first radius and the other segments in the remaining three-quarters of a circle, corresponding to about a 270° circumferential region of the reflector, are filled with other curvature radii.

Using special positioning of the cylindrical facets in the above-described quarter-circle circumferential region, the side wall to be illuminated can be illuminated in a particularly uniform manner and also very far up. Overall a non-rotationally symmetrical illumination intensity distribution is generated in such a light fixture.

A comparable light fixture can also be made for illuminating two opposing side wall regions of a building room, e.g. a longitudinally extended corridor, regions of the floor being illuminated simultaneously. In such an embodiment, the entire inner surface of the reflector is divided into four segments so that there is a dual plane symmetry of the reflector, specifically symmetry to two planes that pass through the center longitudinal axis of the reflector and that are perpendicular to one another and that intersect at the center longitudinal axis of the reflector.

In accordance with another embodiment of the invention, the curvature radii of the segments are constant along a row. Especially uniform illumination intensity distributions can be produced in particular with such an embodiment of the invention, especially mainly rotationally symmetrical illumination intensity distributions that have a nearly constant illumination intensity distribution along the illuminated surface.

The curvature radii of the segments can vary or remain constant along a column. A column is an arrangement of segments that are arranged along an identical circumferential angle, adjacent between the apex and the free edge of the reflector. Whether the curvature radii of the segments vary along a column or are kept constant depends on what illumination intensity distribution is desired. For instance, a relatively narrow, i.e. tightly radiated, light cone or alternatively a quite broad light cone can be attained by changing the curvature radius of the segments along a column.

In accordance with one advantageous embodiment of the invention, segments, in particular cylindrical segments, extend along a partial region of the inner surface of the reflector or along a plurality of partial regions of the inner surface of the reflector. Thus for instance just a quarter circle segment of for instance about 90° of the inner surface of the reflector can be filled with cylindrical segments, while the other three-quarters of the circle (270°) of the reflector is mainly smooth. Thus a reflector with an illumination intensity distribution that deviates from that of a facetless reflector in the desired manner can for instance be produced with less complexity. Alternatively, the inner surface of the reflector can also be filled with cylindrical and with spherical or nonspherical segments combined. Thus a first circumferential angle of the reflector can be filled with cylindrical facets and another circumferential angle of the reflector can be filled with spherical or nonspherical segments.

Finally, the segments, in particular the cylindrical segments, can also extend along an entire inner surface of the reflector.

In accordance with another embodiment of the invention, the angle of deviation varies such that cylindrical segments that are arranged near the free edge of the reflector have larger angles of deviation than segments that are arranged near the apex. With such an arrangement it is possible to reflect an especially large amount of light relatively far outward, i.e. relatively far upward in a ceiling arrangement, so that even the upper regions of a side wall are illuminated.

In accordance with the invention, the segments have at least partially radial undercuts. This means that at least two adjacent segments arranged along a column, that is in the axial direction, are made such that when viewed in the axial direction there is an overlap. This enables particularly advantageous positioning, in particular of the cylindrical facets, such that some light that is emitted by the light source is emitted passing very near the free edge of the reflector. For instance, if the light fixture is being used for a downlight that is intended to also illuminate the side walls of a room, even very high side wall regions can also be illuminated.

Particularly advantageously, the reflector having the cylindrical segments is an aluminum reflector that is produced using a pressing process. It is possible for the first time to attain an undercut arrangement by using suitable inventive, novel tools.

The cylindrical segments can be arranged along annular rows that run angularly and along radial columns that extend from the apex to the edge. Segments of two rows that are spaced apart from one another can have a circumferential angle offset.

The invention moreover relates to a method in accordance with the preamble to claim 35.

One method is known for producing a reflector element for a light fixture from a starting material workpiece. In particular known from applicant's above-described German patent application is producing a faceted reflector from an aluminum disk using a pressing method. After the pressing method, this reflector has a cup shape with a plurality of facet-like segments on its interior.

Starting with the method for the prior art, the object of the invention is comprised in providing a method with which a reflector can be produced, with which reflector an improved variation in the illumination intensity distribution can be attained.

The invention attains this object with the features of claim 35 and is consequently characterized by the steps:

a) providing a starting material workpiece, in particular an aluminum disk;

b) exerting a relative force between the workpiece and a male die, the male die having radial projections for producing undercuts between adjacent segments in the workpiece;

c) performing a radial movement of sections or parts or the male die relative to the reflector element shaped from the workpiece so that the projections are moved out of the undercuts;

d) performing an axial movement of the male die relative to the reflector element for removing the male die from the reflector element.

The principle of the inventive method is comprised initially in that a particular die is prepared that can also be called a male die. The male die has at least two parts that can be displaced relative to one another. While the male die of the prior art was a single massive die part, and a female-type structure was applied to its exterior and engraved or stamped inside the reflector element to produce a male-type structure there, with the inventive method a particular facet structure that has radial undercuts can be produced on the interior of the reflector. However, the production of undercuts in the reflector poses significant problems during removing the die. Axial movement is prevented due to the overlap of every at least two adjacent segments in the radial direction. Thus it is not possible to remove the die with a method from the prior art.

By providing a multi-part female die with the option of displacing at least one part of the female die relative to another part of the female die, the female-side projections can be moved out of the reflector-side undercuts after the pressing process has been performed. Then axial movement of the female die is possible with the reflector held fast. Alternative, the female die can also be held securely, and the reflector can be displaced relative thereto.

Relative force is exerted between workpiece and female die during the pressing process using a special pressing apparatus. It can include for instance a pressing head, for instance in the shape of a roller, and a plurality of lever arms. The relative force during pressing preferably acts mainly in the axial direction, the pressure tool being movable radially and in this manner the entire exterior surface of the reflector moves off. The female die rotates continuously together with the aluminum disk under the pressure tool.

The invention furthermore relates to a tool for producing a mainly cup-shaped curved reflector element in accordance with claim 36.

The object of this invention is comprised in providing a tool with which a reflector can be produced, which reflector can be designed variably in terms of its illumination intensity distribution.

The invention attains this object with the features of claim 36.

The inventive tool includes a shaping surface that functions as a male die part during the shaping process and that has radial projections. Radial projections are for attaining undercuts on the reflector. The male die includes at least one displaceable part that is radially displaceable relative to at least one other part. During the shaping process, the tool provides a continuous shaping surface that, once the reflector has been produced, is mainly consistent with the entire inner surface or interior of the reflector element with a geometrically inverted structure.

Once the pressure process has terminated, due to a radially inward directed displacement movement of the displaceable part of the section, it is possible for the projections to move radially out of the undercuts.

Additional advantages of the invention are seen in the other dependent claims as well as with reference to the following description of a plurality of embodiments that are shown in the figures.

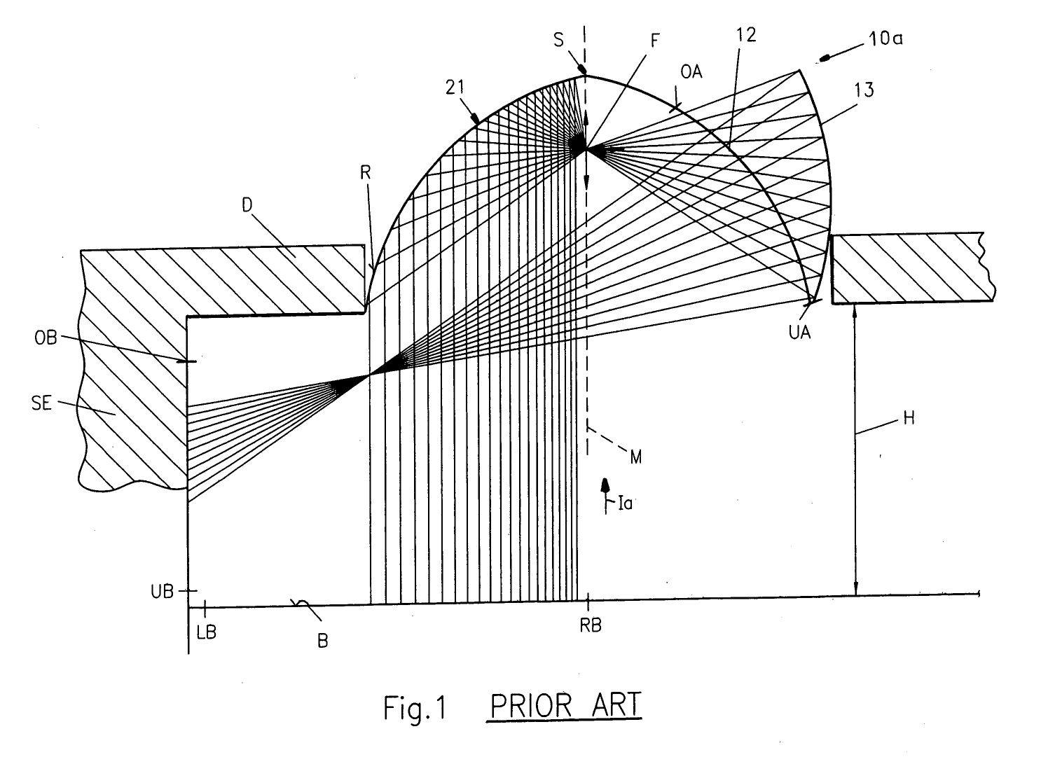

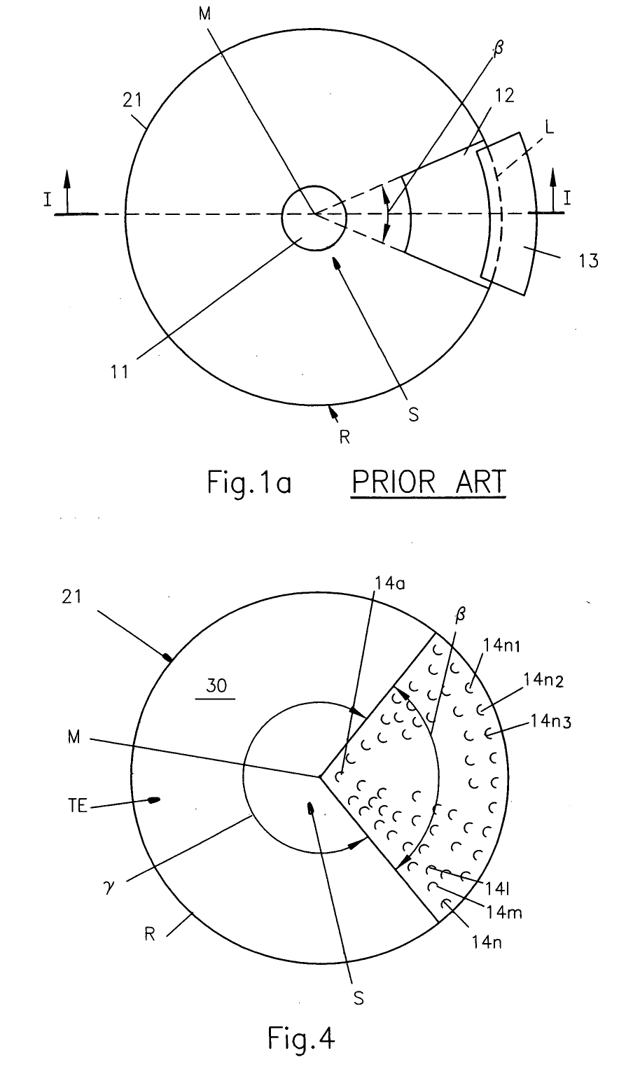

FIG. 1 is a schematic partially sectional view of a prior-art light fixture;

FIG. 1a is a top view of only the reflector of the light fixture from the prior art, approximately in the direction of arrow Ia like FIG. 1;

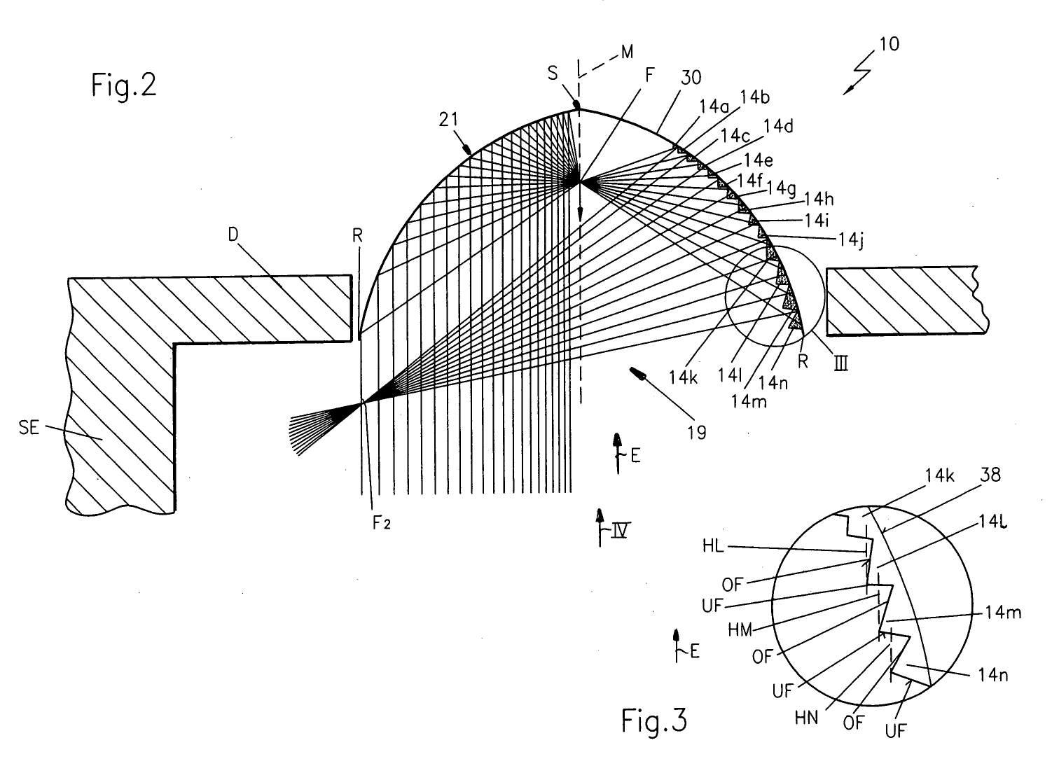

FIG. 2 is a schematic view similar to FIG. 1 of a first embodiment of an inventive light fixture;

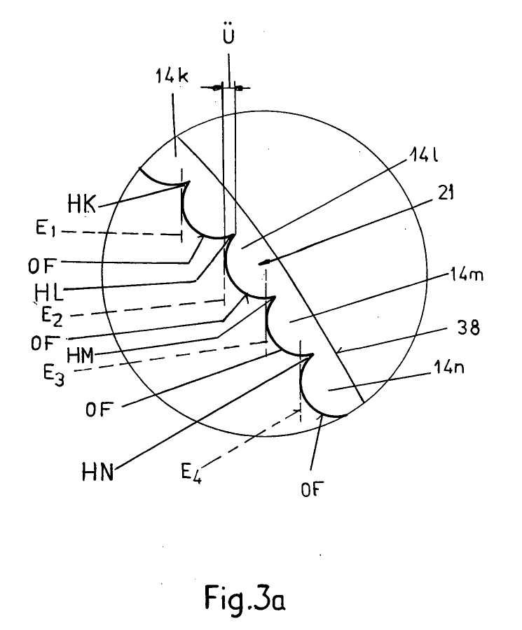

FIG. 3 is an enlarged cross-sectional view in accordance with circled region III in FIG. 2;

FIG. 3a is another embodiment of a reflector element of an inventive lamp in a view like FIG. 3, in enlarged scale, the embodiment of FIG. 3a having spherical segments instead of the cylindrical segments visible in FIG. 3;

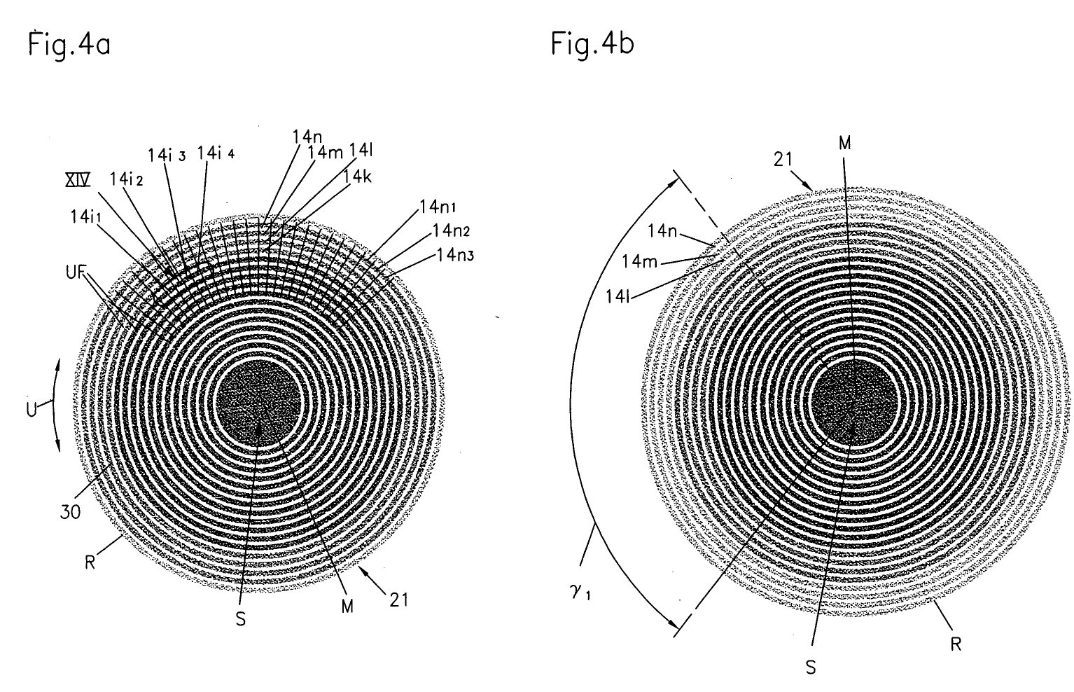

FIG. 4 is an embodiment of a reflector for an inventive light fixture in accordance with arrow IV in FIG. 2 in a very schematic view;

FIG. 4a is a second embodiment of a reflector for an inventive light fixture in a view similar to FIG. 4;

FIG. 4b is another embodiment of a reflector for an inventive light fixture in a view like FIG. 4;

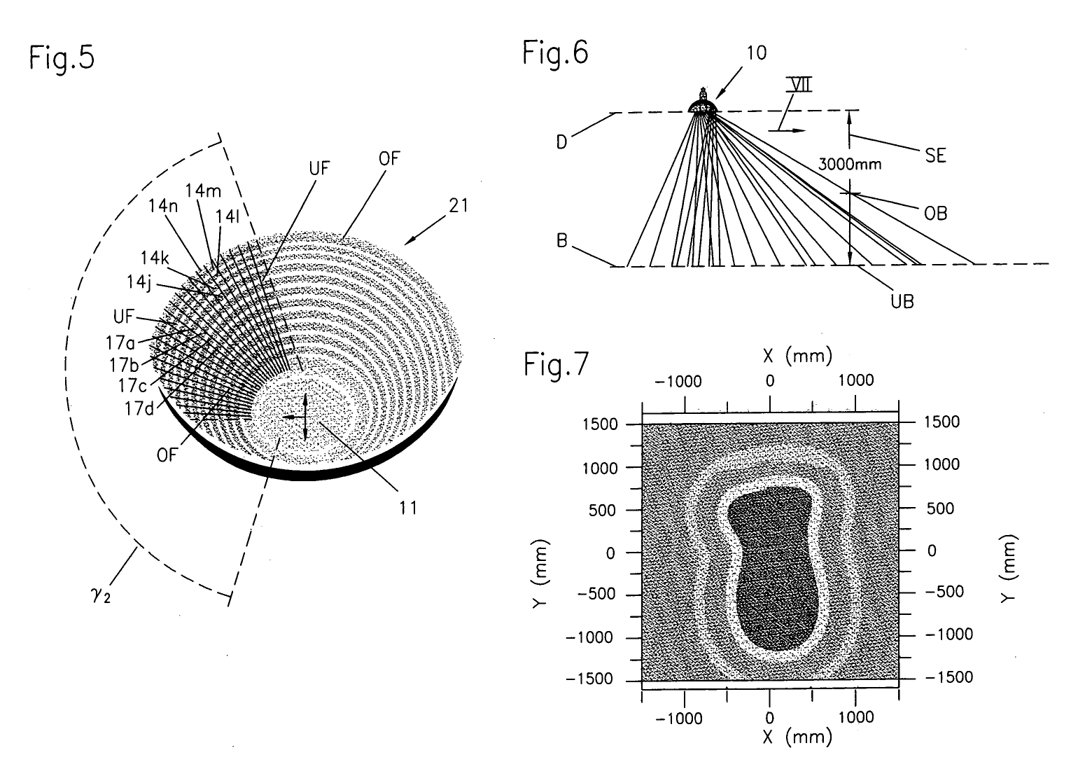

FIG. 5 is another embodiment of a reflector for an inventive light fixture, in a perspective view;

FIG. 6 is a very schematic view like FIG. 1 of a light fixture having the of FIG. 5 and mounted in a ceiling;

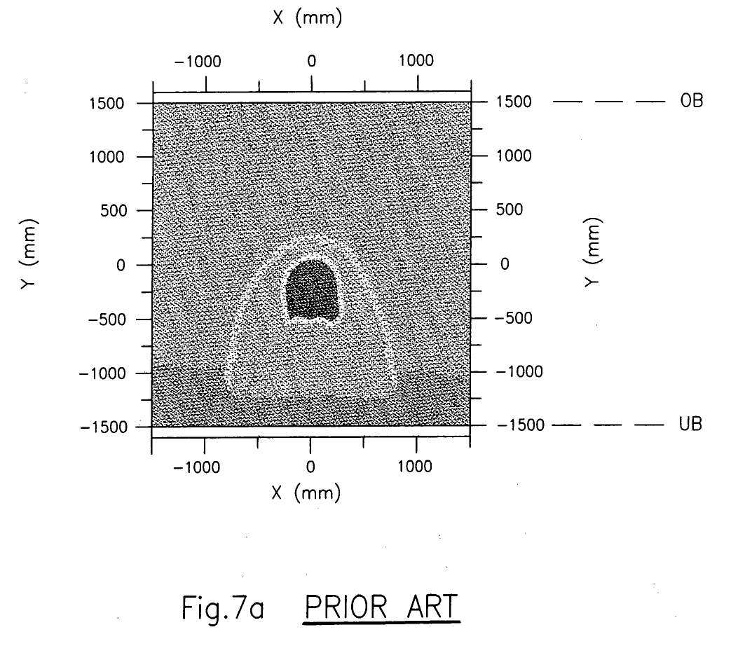

FIG. 7 is a false color representation of the illumination intensity distribution that the light fixture in FIG. 6 produces on a side wall indicated by the double-headed arrow of FIG. 6;

FIG. 7a is a view like FIG. 7 of the illumination intensity distribution that a light fixture from the prior art would produce with a rotation-symmetrical, facet-free reflector on the wall indicated by the double arrow in FIG. 6;

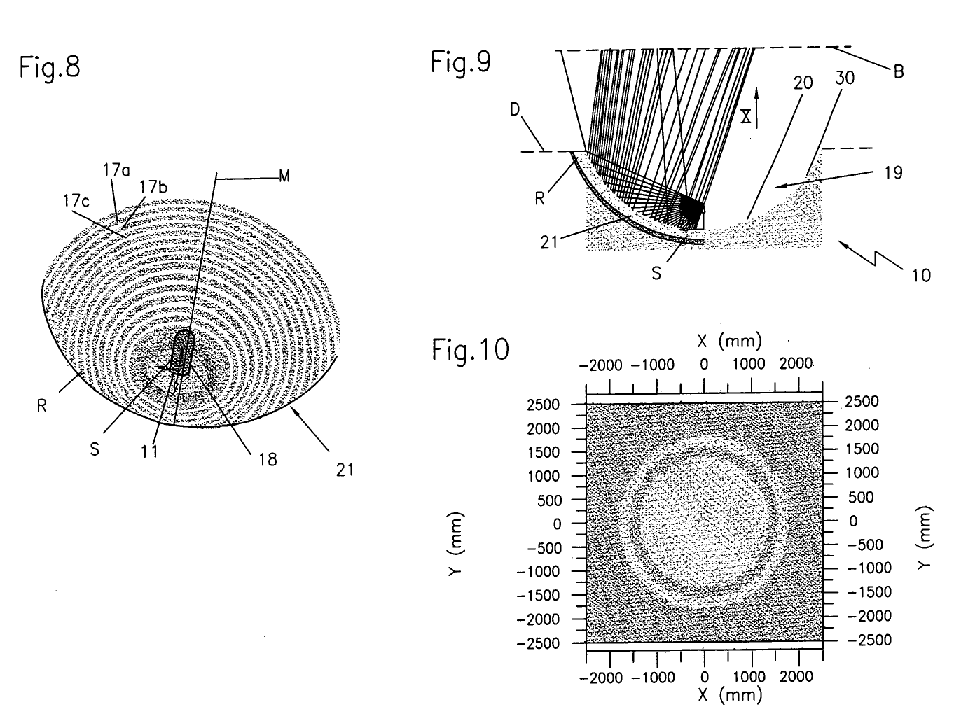

FIG. 8 is another embodiment of a reflector for an inventive light fixture, shown as in FIG. 5;

FIG. 9 is a schematic view illustrating as an example the paths light beams in a view similar to FIG. 6 for a light fixture having a reflector like FIG. 8;

FIG. 10 shows the illumination intensity distribution on a floor that can be attained with a light fixture like FIG. 9;

FIG. 11 shows another embodiment of a reflector for an inventive light fixture in a view like FIG. 8;

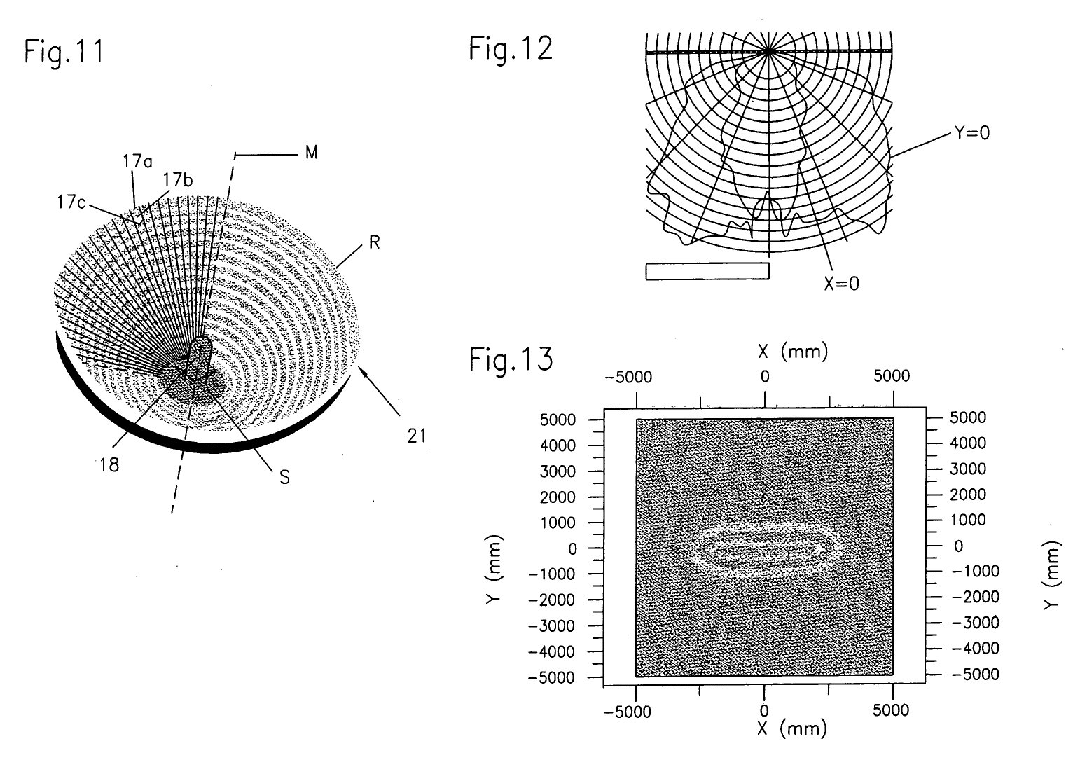

FIG. 12 shows the light distribution curves for a light fixture having a reflector like FIG. 11 in a polar view along two mutually perpendicular viewing planes;

FIG. 13 shows the illumination intensity distribution on a floor for a light fixture like FIG. 12 in a view like FIG. 10;

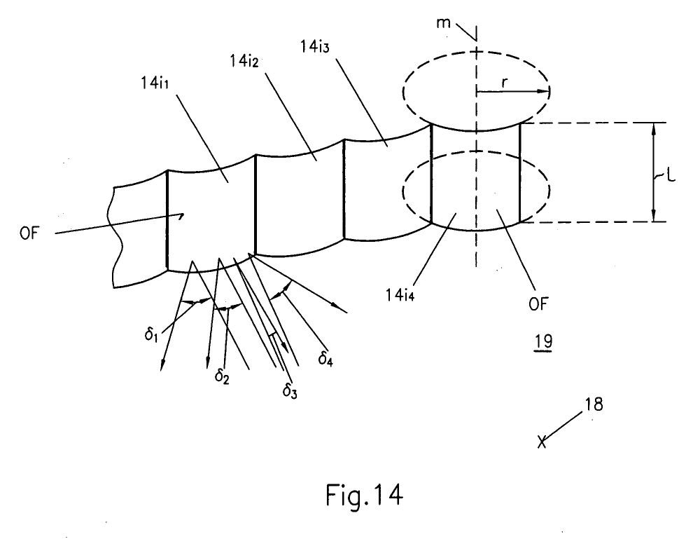

FIG. 14 is an enlarged schematic view of a cutout from a row of facets in accordance with cutout circle XIV in FIG. 4a;

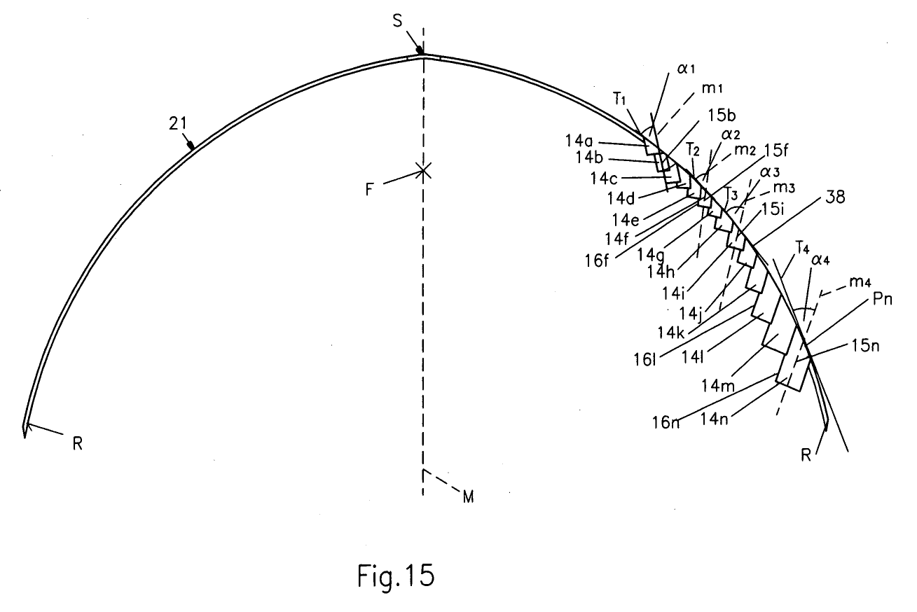

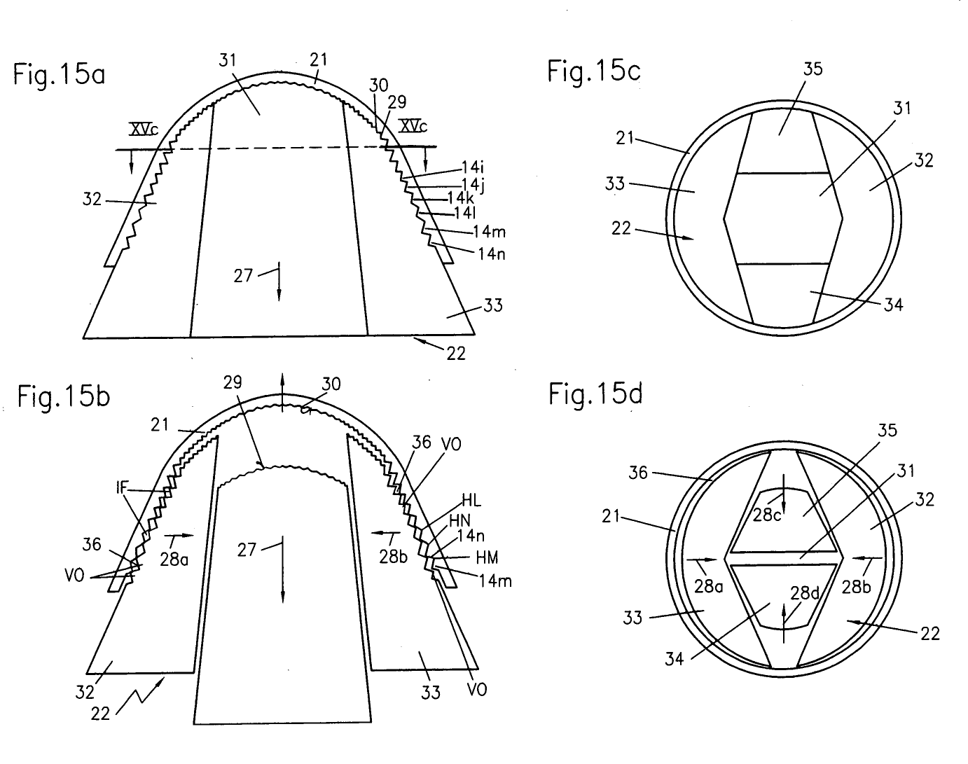

FIG. 15a shows the inventive light fixture like FIG. 2 in a simplified view;

FIG. 15a is an inventive die whose external shape forms the interior of the reflector as the result of a pressing process;

FIG. 15b shows the embodiment in FIG. 15a with a retractile center part;

FIG. 15c is another embodiment of an inventive five-part die in a partial section, schematic top view, approximately in accordance with sectional line XVc-XVc in FIG. 15a;

FIG. 15d shows the embodiment in FIG. 15c, with retracted center tool parts;

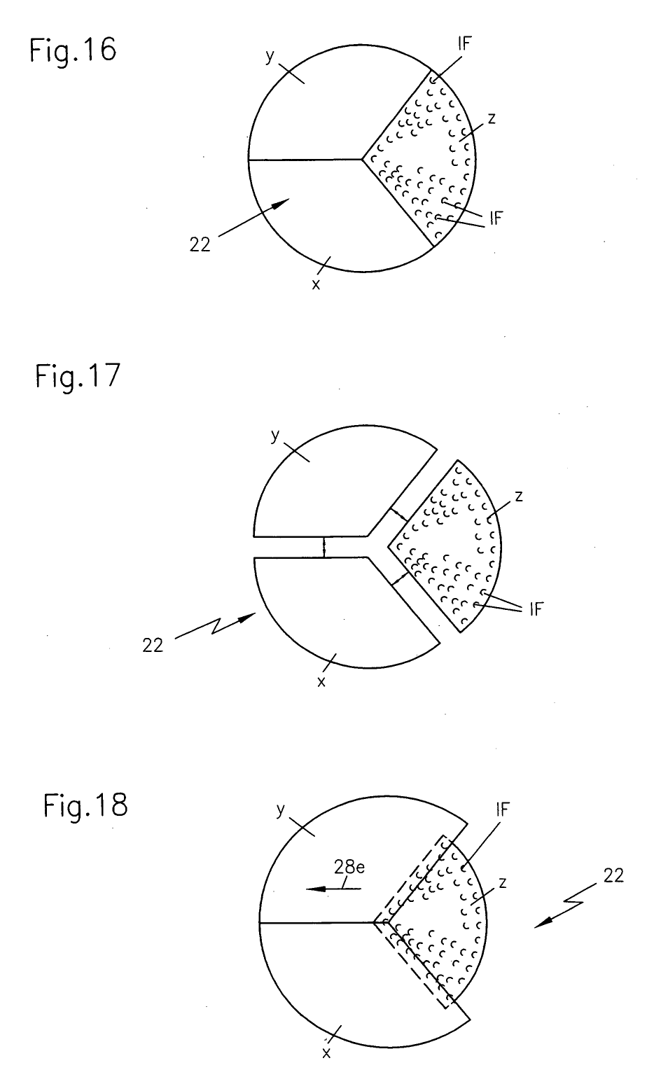

FIG. 16 is a schematic view like FIG. 15c of another embodiment of an inventive three-part die;

FIG. 17 is another embodiment of an inventive die like the die of FIG. 16, the three tool parts being spaced apart from one another radially;

FIG. 18 is another embodiment of an inventive die similar to FIG. 16, where one of the three tool parts is shifted radially inward;

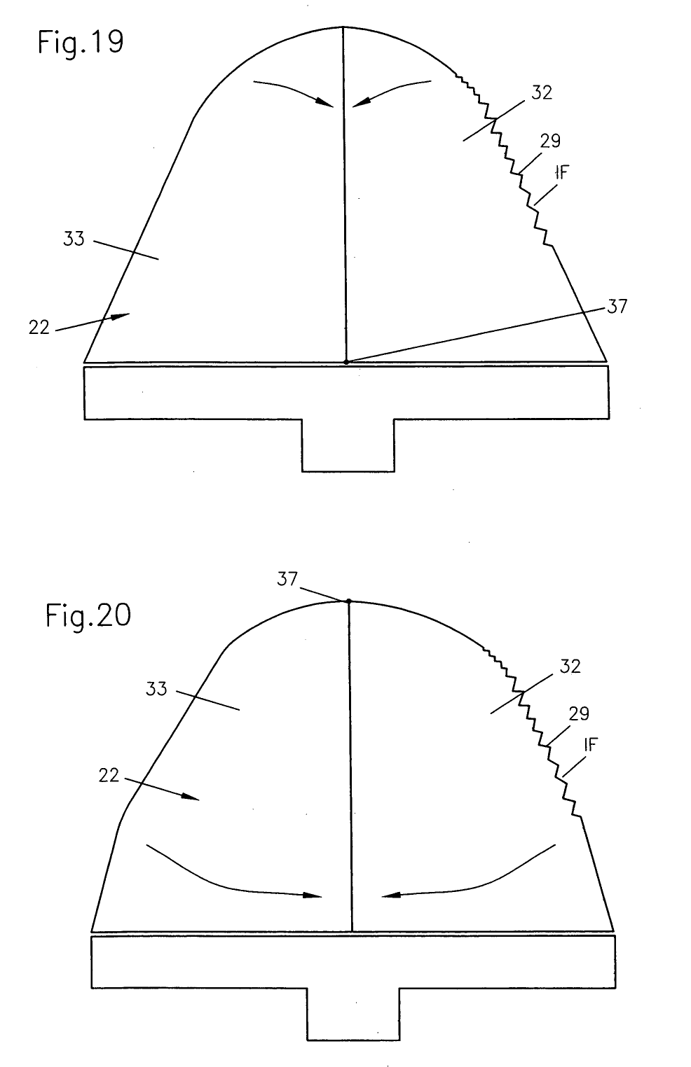

FIG. 19 is another embodiment of an inventive die in which two tool parts are pivotal relative to each other about a lower pivot axis in a foot of the die;

FIG. 20 is a view similar to FIG. 19 of another embodiment of an inventive die in which the two tool parts can be pivoted about a pivot axis that is located near the apex point of the die;

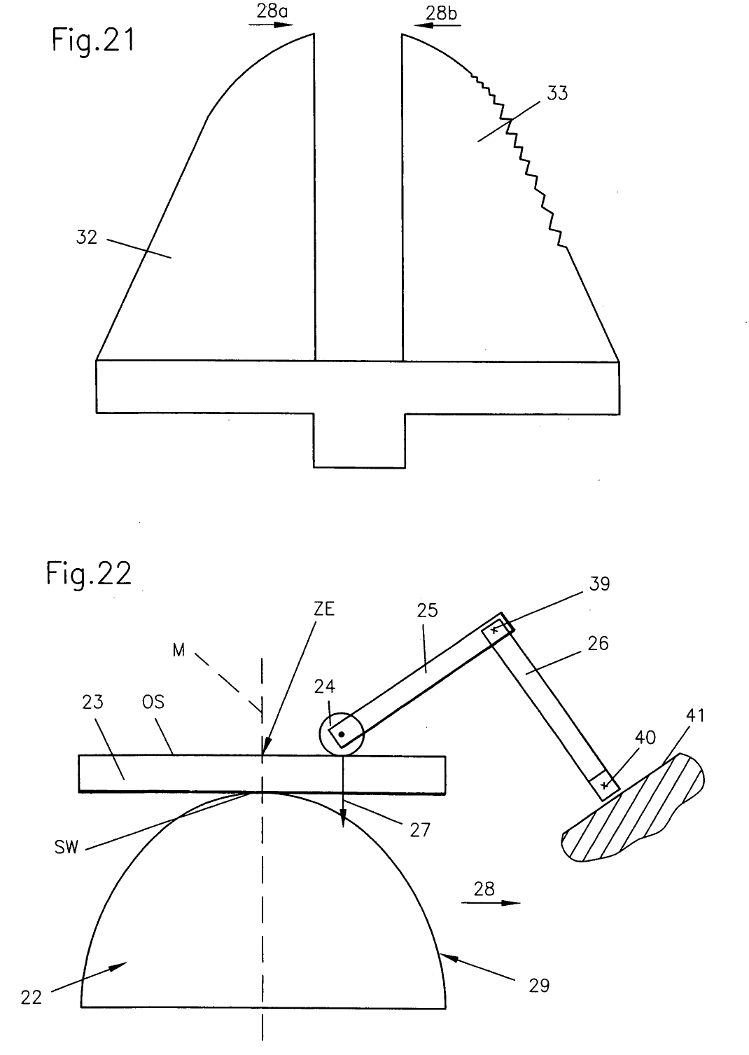

FIG. 21 is another embodiment of an inventive die in which at least two tool parts can be displaced radially relative to one another; and

FIG. 22 is a die and an aluminum disk arranged in the region of the apex and a pressing apparatus.

The inventive light fixture identified at 10 in the figures is described in the following. It should be initially noted that for the sake of clarity comparable parts or elements have been labeled with the same reference numbers, sometimes with the addition of lower case letters and/or numbers as subscripts. This also applies to the prior-art light fixture.

First a light fixture from applicant's prior art will be described with reference to FIGS. 1 and 1a.

As shown in FIG. 1, a light fixture 10a from the prior art is intended to be installed in a ceiling D of a room in a building. The light fixture includes light-emitting means (not shown) that is arranged at a focal point F or near a focal point of a reflector 21. To this end, the reflector 21 is provided in particular at its apex S with an aperture 11 that is not shown in FIG. 1 but that is clearly seen in FIG. 1a, and through which the light emitter can be inserted. The light fixture 10 for the prior art also has a housing (not shown) and a socket or mounts (not shown) for the light emitter, electrical lines, and all other required parts and elements, e.g. operating equipment.

The prior-art light fixture 10a illuminates a floor surface B of the building room, approximately in the region between a left limit LB and a right limit RB, and simultaneously illuminates a side wall SE, specifically approximately between a lower limit UB and an upper limit OB. The reflector 21 of the light fixture 10a has a cross-section that is mainly parabolic and is mainly rotationally symmetrical about its center longitudinal axis M. The interior of the reflector is mainly smooth, i.e. there are no segments or bumps formed on the inner surface.

As can best be seen from FIG. 1a, an region of the circumferential angle β is provided with an edge notch 12. The edge notch 12 lets light emitted from the light source at the focal point F fall onto a separate reflector element 13. The reflector element 13 is thus mounted outside the envelope of the reflector 21. The region of the reflector 21 that in FIG. 1 is provided between an upper edge OA and the lower edge UA is thus cut out, which is not clear in FIG. 1 but is clearly shown in FIG. 1a. Starting from the light source, the light can travel directly to the reflector element 13 without being intercepted by the reflector 21. The broken line L shown in FIG. 1 shows the free edge R of the reflector 21 in the region of the notch 12 before the notch was made.

The reflector element 13 serves to illuminate the side wall SE as high up as possible, that is, as close to the ceiling D as possible. Uniform illumination of the side wall SE is particularly desired.

While the beam bundle that goes out from the light source and that in FIG. 1 is shown in the left-hand half of the reflector 21, to the left of the center longitudinal axis M of the reflector, is reflected on the left-hand reflector half and falls mainly parallel downward onto the floor B, the light striking the element 13 inside the circumferential angle β can illuminate the side wall SE. Thus light distribution that is generally asymmetrical results.

Production of such a reflector like FIGS. 1 and 1a is very complex, since first a mainly rotationally symmetrical reflector must be produced, it must then be punched or cut out, and finally it must be fitted with a separate reflector element 13. In addition, the separate reflector element 13 must be produced separately and during assembly must be positioned very precisely relative to the reflector 21.

In contrast, production of an inventive light fixture that is described in the following is clearly more simple and in particular offers a plurality of advantages in terms of light engineering. An inventive light fixture 10 is first described with reference to FIG. 2:

FIG. 2 shows a first embodiment of an inventive light fixture 10 in a view like FIG. 1.

When viewing FIG. 1, it is initially clear that the inventive light fixture 10 is also suitable for mounting in the ceiling D and for illuminating a building side wall SE and a floor B. For the sake of clarity, the floor B and the lower part of the side wall SE from FIG. 1 have been omitted in FIG. 2.

A comparison of FIG. 1 and FIG. 2 moreover shows how the two reflectors have mainly the same basic shape. Both reflectors 21 are mainly cup-shaped and are of parabolic section. It is immediately apparent that a step-like or sawtooth-like structure is formed on the interior 30 of the reflector 21 for the inventive light fixture 10. This sawtooth-like structure is formed in the embodiment of FIG. 2 by cylindrical segments and is described in detail in the following with reference to FIGS. 2, 3, 4, 4a, 14, and 15.

In a very schematic top view, FIG. 4 shows a view of the interior of the reflector 21 for a light fixture according to the invention like FIG. 2. Here it is clear that a plurality of cylindrical, facet-like segments 14n, 14m, 14i, 14n₁, 14n₂, 14n₃, are arranged on the inner surface 30 of the reflector 21 along a circumferential angle β. As can be seen from the embodiment shown in FIG. 4, the remaining region of the reflector, labeled γ, is facet-free, i.e. is mainly smooth. This facet-free region is labeled THE and represents a partial region of for instance about 250°, while the angularly extending region β is about 110°. Naturally the size of the angularly extending regions β and γ can vary according to the desired application. The number of differently shaped regions can also be varied according to application. FIG. 4a shows an embodiment of an inventive reflector 21 that has been modified relative to FIG. 4 and in which the inner surface 30 of the reflector is entirely filled with cylindrical segments. FIG. 4b shows an embodiment of an inventive reflector 21 that has been modified relative to FIG. 4a.

FIG. 2 shows how a plurality of cylindrical facets 14a, 14b, 14c, 14d, 14e, 14f, 14g, 14h, 14i, 14j, 14k, 14l, 14m, and 14n are provided starting from an apex S of the reflector 21 to a free edge R of the reflector. FIG. 3a shows the facets 14k, 14l, 14m, 14n in an enlarged partial cut-away view corresponding to circle III in FIG. 2. These are offset cylindrical facets that are arranged adjacent in columns next one another between the apex point and the edge R of the reflector 21.

FIG. 4a shows how a plurality of facets are arranged immediately adjacent one another in the angular direction U. Thus, in FIG. 4a, in the outermost row there are three segments labeled 14n₁, 14n₂, 14n₃, FIG. 4a shows for instance in the sixth outermost row segments labeled 14i₁, 14i₁, 14i₂, 14i₃, and 14ni₄. These four segments are shown in an enlarged view in FIG. 14.

FIG. 14 schematically shows a light source 18 from which a parallel beam bundle is radiated that for instance strikes a surface OF of the cylindrical segment 14i₁. A beam bundle having four parallel beams is shown.

As can be seen as an example using this cylindrical segment 14i₁, the surface OF of each cylindrical segment 14i₁, 14i₂, 14i₃, 14i₄, that is convexly arcuate toward the interior 19 of the reflector 21 and that is formed by a cylinder that is has a radius r, length l, and center axis m. In FIG. 14, the radius r and the cylinder center axis m are shown with a broken line for segment 14i₄. It is significant that each of the cylindrical segments 14i₁, 14i₂, 14i₃, 14i₄ can be defined using its radius r, its cylinder center axis m, and its cylinder length l.

The parameters m, r, and l can vary for the individual segments. In particular the orientation of the cylinder center axis m varies as a function of the distance of the individual segment from the apex S of the reflector 21 to the orientation of the tangent that can be applied to the reflector at the connecting point or connecting region 15 of the segment.

Due to the curvature of the surface OF with the radius r, the parallel beam bundle that strikes the segment 14i₁ is spread. The four light beams shown in the example have different angles of reflection δ₁, δ₂, δ₃, δ₄, relative to the parallel incident light beams.

All of the other cylindrical segments 14i₂, 14i₃, 14i₄ naturally demonstrate comparable radiating behavior.

The number of segments along a column and the number segments along a row can be freely selected. The number of columns and the number of rows are also freely selectable.

While the curvature of the cylindrical reflecting surface OF can take care of broad homogenization of the light intensity distribution, in accordance with the inventive teaching it is only possible to attain a desired illumination intensity distribution with a special orientation, to be described later, of the cylindrical segments while providing undercuts HI, HM, HN. To this end reference is made initially to FIGS. 2 and 15.

FIG. 15 is an enlarged schematic view of the reflector 21 of the inventive light fixture 10 as in FIG. 2. In this case, all of the cylindrical segments 14a, 14b, 14c, 14d, 14e, 14f, 14g, 14h, 14i, 14j, 14k, 14l, 14m, 14n that are provided in a column are shown. The reflector 21 has an apex S and an edge R, the cross-sectional shape being shaped as a parabola having the focal point F. In terms of its basic shape, the reflector 21 is rotationally symmetrical about the center longitudinal axis M. As can be seen from FIG. 4 and in particular FIG. 4b, however, the cylindrical segments do not have to be distributed rotationally symmetrically.

The cylindrical segments 14a, 14b, 14c, 14d, 14e, 14f, 14g, 14h, 14i, 14j, 14k, 14l, 14m, 14n are each connected to the reflector 21 via a connecting region 15. The part of a cylindrical segment with which each segment meets the basic shape of the reflector is called the connecting region 15. For instance, the segment 14n has a connecting region 15n that is located approximately in the vicinity of a point of intersection Pₙ for the indicated cylinder axis m₄ with the parabolic basic shape of the reflector 21.

A tangent T₄ can be placed on the exterior 38 of the reflector 21 in the region of this point of intersection Pₙ. In terms of its orientation, the tangent T₄ has nothing to do with any structure of the exterior 38 of the reflector 21 and is a tangent in the mathematical sense that is placed on the mathematical curve that produces the basic shape of the cup-shaped curved reflector 21.

In a reflector 21 that is very thin-walled, the external shape 38 of the reflector 21 is nearly the mathematically ideal parabolic curve that produces the basic shape of the reflector, or at least comes very close thereto. The angle between the cylinder axis m₄ and the associated tangent T₄ is labeled α₄ in FIG. 15. α₄ is the so-called deviation mean.

The segment 14, that is closer to the apex than the segment 14ₙ, is similarly fixed to the reflector 21 at its connecting region 15ₗ. The associated cylinder axis m₃ intersects the associated tangent T₃ at an angle of deviation α₃. The same applies for all of the other shown cylinder facets, for reasons of clarity in FIG. 15 only the segments 14_{b} and 14f being labeled with their cylinder axes m₁, m₂ and angles α₁, α₂ of deviation.

The angles α₁, α₂, α₃, α₄ of deviation vary. The mirror surfaces 16a, 16b, 16c, 16d, 16e, 16f, 16g, 16h, 16i, 16j, 16k, 161, 16m, 16n, that is, the reflecting surfaces OF, of the individual segments 14a, 14b, 14c, 14d, 14e, 14f, 14g, 14h, 14i, 14j, 14k, 14l, 14m, 14n are inclined differently relative to the center longitudinal axis M of the reflector 21. The inclination of the mirror surfaces 16a, 16b, 16c, 16d, 16e, 16f, 16g, 16h, 16i, 16j, 16k, 161, 16m, 16n can be selected entirely independent from the basic shape of the reflector 21.

In particular it is possible to illuminate side wall regions SE of a building room up to near the ceiling D by setting the appropriate steepness, preferably of the segments near the edge R of the reflector 21.

The connection or steepness setting for the cylindrical facets 14a, 14b, 14c, 14d, 14e, 14f, 14g, 14h, 14i, 14j, 14k, 14l, 14m, 14n is accomplished such that the cylinder axes m, m₁, m₂, m₃, m₄ assume different angles α₁, α₂, α₃, α₄ of deviation to the associated tangents T₁, T₂, T₃, T₄. The variation in the angles of deviation does not necessarily have to follow certain prespecified rules, such as for instance a rule according to which the angle of deviation for the segment increases from the apex S to the edge R of the reflector. Rather, the angle of deviation can vary as desired. In particular the variation in the angle of deviation is determined by optimizing during a simulation process until a desired illumination intensity distribution is attained.

The inventive teaching also includes light fixtures 10 in which the segments near the apex of the reflector 21 have larger angles of deviation than the segments near the edge R. In addition, individual facets can have larger angles of deviation and other segments, where necessary even adjacent segments can have smaller angles of deviation.

The view of the tangents T₁, T₂, T₃, T₄ as in FIG. 15 is merely schematic. The view if FIG. 15 does not take into account the actual wall thickness of the reflector. When determining the orientation of the tangents, a mathematical curve should be assumed that best corresponds to the curved basic shape of the reflector. This curve is a parabola having the focal point F in the embodiments in FIG. 15 and FIG. 2.

In addition to or as an alternative to production of a high illumination intensity in an upper side wall region, as desired in the embodiment in FIG. 2, if so desired it is also possible, using the connection of the cylindrical facets, which is particularly easy to recognize in FIG. 15, to attain improved homogenization of the illumination intensity distribution on a floor or another surface to be illuminated. Specifically, the reflective surfaces 16a, 16b, 16c, 16d, 16e, 16f, 16g, 16h, 16i, 16j, 16k, 161, 16m, 16n of the cylindrical segments 14a, 14b, 14c, 14d, 14e, 14f, 14g, 14h, 14i, 14j, 14k, 14l, 14m, 14n can be completely positioned as desired, using simulation programs, in particular using so-called ray tracing methods, the positioning of the facets can be optimized individually according to the desired application.

The use of facets, in particular cylindrical facets with undercuts HL, HM, HN, has proven to be particularly advantageous during the course of optimizing the illumination intensity distribution. In addition to using cylindrical segments, it is advantageous to connect the cylindrical facets such that the mirror surfaces 16a, 16b, 16c, 16d, 16e, 16f, 16g, 16h, 16i, 16j, 16k, 161, 16m, 16n, that are of the facets and that face the interior of the reflector 21 are oriented entirely freely in their orientation and specifically independent of the basic shape of the reflector.

The inventive teaching can be implemented in a particularly advantageous manner when a cross-sectionally parabolic reflector is to imitate a cross-sectionally elliptical reflector in terms of its light distribution. FIG. 2 shows this embodiment. The light beams sent out to the right starting from the light source in the focal point F all cross at a second focal point F2 outside of the reflector. Thus the cylindrical segments 14a, 14b, 14c, 14d, 14e, 14f, 14g, 14h, 14i, 14j, 14k, 14l, 14m, 14n that are provided on the interior 30 of the mainly parabolic reflector 21 can simulate or imitate the radiation behavior of a mainly elliptical reflector, the cross-sectionally parabolic reflector 21 permitting a much shallower installation depth and installation width than would be required for an elliptical reflector.

Primarily segments that are based on a circular cylindrical body are understood to be cylindrical segments in the sense of this patent application. However, in certain applications there is also the option of selecting as cylindrical basic bodies for the cylindrical facets bodies that do not have a circular cylindrical basic shape and for instance have an elliptical cylindrical cross-section.

In a view similar to FIG. 3, FIG. 3a shows a partial cross-section through the reflector element 21 in which the cylindrical segments 14l, 14m, 14n in FIG. 3 are replaced with spherically curved segments 14k, 14l, 14m, 14n. In the embodiment in FIG. 3a the reflecting surface OF of each individual segment is thus not formed by a body with a cylindrical basic shape, but rather by a mainly part-spherical body. Alternatively, in the embodiment in FIG. 3a the segments 14k, 14l, 14m, 14n can also each be formed by a cylindrical body, the cylinder axis of which runs mainly angularly of the reflector 21 so that the cylinder axis, relative to FIG. 3a, thus extends perpendicular to the plane of the paper. In this case the cylinder axis is the axis of curvature of each segment 14k, 14l, 14m, 14n.

FIG. 3a makes it clear in particular that undercuts HK, HL, HM, HN are provided even in the embodiment in FIG. 3a. Analogous to the embodiment in FIG. 3, the broken lines E₁, E₂, E₃, E₄ represent lines that run parallel to the insertion direction or axial direction or die-removing direction E. The insertion direction E is again parallel to the center longitudinal axis M of the reflector.

Thus, the dead spaces that are labeled HK, HL, HM, and HN and that are each located outside of the broken lines E₁, E₂, E₃, E₄ are radial undercuts in the sense of the invention. These are shadow spaces or dead spaces that a viewer looking from a perpendicular viewing direction along the center longitudinal axis N into the interior 19 of the reflector 21 does not see. Every two adjacent segments overlap one another in the radial direction. In addition, for instance the segment 14k in FIG. 3a overlaps the adjacent segment 14l in the overlap region Ü. The undercut HL produced in this manner is located radially outside the associated insertion direction labeled E₂. The broken line E₂ thus indicates a radially innermost tangent that can be placed on the segment 141 that is near the edge, parallel to the center longitudinal axis M of the reflector 21.

FIG. 4 shows an embodiment of a reflector 21 in which only one region of the inner surface 30 of the reflector, which region extends along the circumferential angle β, is filled with cylindrical segments 14n₁, 14n₂, 14n₃, 14l, 14m, 14n, while a partial region THE of the inner surface 30 of the reflector, approximately along the circumferential angle γ, is segment-free and thus is mainly smooth. The embodiment in FIG. 4 is intended to make clear that different sizes and different numbers of partial regions of the inner surface 30 of the reflector 21 can be filled with segments, in particular with cylindrical segments, depending on the application. It should also be noted at this point that a partial region of the reflector 21 can be filled with segments of a first type, for instance with cylindrical segments, and another partial region can be filled with segments of a second type, for instance with spherical segments or nonspherically curved segments or alternatively with a flat surface.

In contrast, FIGS. 4a and 4b show two embodiments of a reflector 21 for an inventive light fixture, the inner surface of which 30 is completely filled with cylindrical segments. With regard to the following description of the figures, it is assumed that the embodiments for FIGS. 4a, and 4b, 5, 8, and 11 have reflectors that have at least a few radial undercuts in the sense of the invention.

FIG. 4a shows an embodiment of a reflector 21 in which the segments are arranged along circular rows. Thus for instance the segments 14n₁, 14n₂, and 14n₃ are arranged along an outermost row of segments and the segments 14i₁, 14i₂, and 14i₃ are arranged along a different, sixth outermost row of segments. The segments 14n, 14m, 14l, 14k are arranged along a column of segments.

In the embodiment in FIG. 4a, the radii of curvature of the individual segments along a row vary. In one alternative embodiment, the radii of curvature can however also be constant along a row. In this alternative embodiment only the orientation of the cylinder axes changes.

FIG. 4b shows an embodiment of a reflector 21 that has been modified relative to FIG. 4a and in which adjacent reflector rows along a circumferential angularly extending region γ₁ are circumferentially offset. The other region of the reflector 21 in FIG. 4b does not have this circumferential staggering.

In the reflector in FIG. 5 the circumferential offset adjacent along an angular region γ₂ becomes particularly clear. There the circumferential angularly extending region labeled γ₂ is filled with rows of cylindrical segments, every two adjacent rows, e.g. rows 17a and 17b or rows 17b and 17c, being arranged circumferentially offset to one another by half a segment width. On the other hand, the embodiments in FIGS. 8 and 11 do not have this circumferential offset.

It can also be seen from FIG. 5 that the rows 17a and 17c and the rows 17b and 17d do not have this circumferential offset relative to one another. That is, every second row is shaped without a circumferential offset.

Viewed together, it is clear from FIGS. 3, 4a, and 5 that, of the cylindrical segments 14a, 14b, 14c, 14d, 14e, 14f, 14g, 14h, 14i, 14j, 14k, 14l, 14m, 14n, only the cylindrically curved surface OF contributes to the light reflection. The surfaces facing the light outlet aperture of the reflector 21 in FIG. 3 and labeled UF do not have any technical light function. The surfaces labeled UF are shown light in FIGS. 4a and 5, while the cylindrical reflecting surfaces OF in FIGS. 4a and 5 are shown dark.

Moreover, the embodiments in FIGS. 4a, and 4b make it clear that the size of the surfaces UF can be selected entirely different from row to row and also along a row. This clearly results from the different size regions that are shown light in FIGS. 4a and 4b.

It can be seen from FIG. 5 [sic; FIG. 15] that all cylinder axes m₁, m₂, m₃, m₄ of the corresponding segments 14b, 14f, 14i, 14n are set at an acute angle to the center longitudinal axis M of the reflector 21. It can also be seen from FIG. 15 that the segments located near the apex S of the reflector, e.g. the segments 14_{b} and 14_{f}, have quite a small angle of 21° or 5° to the center longitudinal axis M, while the angle of the cylinder axis m₃ of the segment 14i is nearly 0°. In contrast, the cylinder axis m₄ has a large acute angle relative to the center longitudinal axis M.

The variation in the angles of deviation can be seen clearly in FIG. 15. Thus, the angle of deviation α₄ is about 43°, while the angle of deviation α₂ is about 34°. Such angles of deviation on the order of magnitude of 5° of the cylinder axes to the associated tangents can be adequate for producing significant changes in the illumination intensity distribution.

At this point it should furthermore be noted that the mirror surfaces 16 of the individual segments 14 each run parallel to the cylinder axes m. Thus for instance the clear mirror surface 16ₙ of the segment 14ₙ in FIG. 15 is arranged parallel to the associated cylinder axis m₄.

Finally, it should be noted at this point that the entire inner surface 30 of the reflector 21 is advantageously filled with cylindrical segments.

A floor B and a wall SE can be illuminated using the embodiment of an inventive reflector 21 like FIG. 5, in particular when using the reflector 21 in an inventive light fixture 10 in an arrangement like FIG. 6 in a ceiling mount. FIG. 6 shows the paths of a plurality of exemplary light beams, assuming that no building side wall is situated along the double arrow SE, but rather that merely a floor is to be illuminated. In fact the light fixture like FIG. 6 also illuminates a side wall SE that extends along the double arrow SE across e.g. a room height of 3 m.

FIG. 7 shows the illumination intensity distribution that results on the side wall SE, approximately between the lower limit UB and the upper limit OB. The width of the wall is given in millimeters on the X axis, and the height of the wall is given on the Y axis. Each 0 point represents the center of the wall, the center longitudinal axis of the reflector 21 for the inventive light fixture 10 like FIG. 6 being arranged at x=0 and y=1500 mm. A wide, uniform illumination intensity distribution can clearly be seen from FIG. 7. The view in FIG. 7 indicates the illumination intensity distribution in a false color view, the illumination intensity decreasing from the inside to the outside. The difference from the prior art is particularly clear when FIG. 7 is compared to FIG. 7a. FIG. 7a shows an illumination intensity distribution for a light fixture from the prior art, specifically a conventional rotationally symmetrical flood reflector. Such a flood reflector from the prior art is rotationally symmetrical about the center longitudinal axis and has a parabolic cross-section. The inner surface is mainly smooth, i.e. without facets or segments. A similar illumination intensity distribution can also result when spherically curved facets are arranged on the interior of a flood reflector.

FIG. 7a shows the illumination intensity distribution on the same scale as FIG. 7, assuming that such a light fixture from the prior art is installed in the ceiling in an installation position like FIG. 7. It is clear that a clearly more uniform illumination intensity distribution that reaches farther upward and outward results with the inventive light fixture using a reflector like FIG. 5, as can be seen from FIG. 7.

An illumination intensity distribution like FIG. 7 cannot be attained just with spherical or nonspherical or otherwise oriented cylindrical facets. Cylindrical facets are required to obtain an illumination intensity distribution like FIG. 7.

FIG. 5 shows an embodiment of an inventive light fixture 10 that can be used for instance as a downlight or even as a spotlight. In both cases, the light fixture 10 illuminates a floor B and a side wall SE.

FIG. 8 is a view like FIG. 5 of another embodiment of a reflector 21 for an inventive light fixture. In terms of its basic shape, the reflector is mainly rotationally symmetrical about its longitudinal center axis M. In this case the curvature radii of the cylindrical segments do not vary along a row of facets. Simply by positioning the segments, i.e. using the positioning of the cylinder axes m relative to the tangents T with different angles α of deviation as described for the embodiment in FIG. 15, an illumination intensity distribution is obtained like FIG. 10 that is characterized by higher uniformity.

FIG. 9 is a schematic illustration of the beam paths using a few exemplary light beams, the light fixture 10 being mounted to the ceiling D and illuminating a floor B. FIG. 9 illustrates the system in an arrangement shown rotated by 180°. FIG. 10 illustrates the illumination intensity distribution of the light fixture 10 like FIG. 9 on the floor B. It is evident that a mainly rotationally symmetrical illumination intensity distribution is obtained that is nearly constant along a large surface circular region.

FIG. 11 illustrates another embodiment of an inventive reflector configuration for an inventive light fixture in which the curvature radii of the cylindrical facets vary along a row of facets. Likewise, in accordance with the inventive teaching the cylindrical segments are positioned such that the cylinder axes have different angles of deviation to the associated tangents. A mainly oval illumination intensity distribution like FIG. 13 can be obtained with an inventive light fixture using a reflector like FIG. 11. With such a light fixture it is possible for instance to illuminate a sculpture so that the reflector 21 like FIG. 11 can be used as a sculpture spotlight. The use of separate sculpture lenses is not necessary when using a reflector 21 like FIG. 11. The polar light distribution curve like FIG. 12 shows the illumination intensity distribution of FIG. 13 along the axes X=0 and Y=0 in a polar, i.e. angle-dependent, view.

FIGS. 15a-22 shall now be used in the following to explain the inventive manufacturing method for an inventive reflector 21 for an inventive light fixture 10.

Preferably the inventive reflector is made from an aluminum disk, i.e. a mainly circular disk made of aluminum, by pressing. FIG. 22, in a very schematic view, illustrates the aluminum disk 23 that is placed on an apex SW of a die 22. The die 22, the so-called male die, and the aluminum disk 23 rotate together about the center longitudinal axis M. The drive required for this is not shown.

A pressing tool includes a pressing head or pusher 24, e.g. a rotatable wheel, and two lever arms 25 and 26 that can pivot about pivot axes 39 and 40, respectively, attached to a stationary attachment site 41. The pressing head 24 moves in the radial direction of the arrow 28 from the center ZE of the aluminum disk 23 outward and is continuously on the top face OS of the aluminum disk 23 and exerts thereon great pressing force in the direction of the arrow 27, that is, in the axial direction. The manner in which the pressing force is exerted by the pusher 24 onto the top face OS of the aluminum disk 23 is as desired and is not shown.

During the pressing process, the pressing head 24 constantly presses the edge of the aluminum disk 23 against the outside face 29 of the die 22. It can follow the shape of the outside face 29 both in the axial direction of the arrow 27 and in the radial direction of the arrow 28. This is possible by means of the pivotable lever arms 25 and 26. It should be noted that the pressing tool with the pressing head 24 and lever arms 25, 26 can have a completely different basic shape, it merely must be assured that the pressing head 24 is able to exert pressing forces in the axial direction 27 and can travel in the radial direction 28.

Starting from a position like FIG. 22, as the die 22 rotates, the pressing head 24 presses, together with the die 22 as the rotating aluminum disk 23 rotates, the disk along the outside surfaces of the die 22 so that the cup-shaped curved basic shape of the reflector 21 results, e.g. like FIG. 15. It should be noted that the cylindrical or spherical segments on the reflector 21 described in the foregoing are worked into the outside shape 29 of the die 22, comprising e.g. hard steel, as a geometrically inverted structure IF, for instance by laser engraving. In cross-section, the outside shape 29 possesses e.g. a sawtooth-like structure. As can be seen for instance from FIG. 15b, the structure on the outside face 29 of the die 22 is impressed in the interior 30 of the reflector 21 after the pressing process has concluded.

While the production of an aluminum reflector for light fixtures with curved segments is already known from applicant's above-described German patent application DE 10 2004 042 915 A1, the production of an aluminum reflector with undercut facets in a pressing process presents problems.

In accordance with the invention, a die 22 is suggested that comprises a plurality of parts that can be displaced relative to one another. In the embodiment in FIGS. 15a and 15b, the die comprises a center part 31, a left-hand edge part 32, and a right-hand edge part 33. The center part 39 runs conically upward and can be displaced in the axial direction of the arrow 27 and in the opposite direction. In this manner it can be inserted like a wedge between and removed from between the two edge parts 32 and 33. The two edge parts 32 and 33 are displaceable radially, at least along a slight displacement path, in the direction of the arrows 28a and 28b as soon as the center part 31 opens an appropriate movement space for the edge parts 32 and 33.

When inserted like FIG. 15a, the edge parts 32 and 33 with the center part 31 form a continuous external shape 29 that is to be impressed on the inner surface 30 of the reflector 21. When withdrawn like FIG. 15b, the center part 31 has been displaced downward relative to the exterior parts 32 and 33 in terms of FIG. 15b. Due to the conical shaping of the center part 31, the wall parts 32 and 33 can be displaced radially inward, which is indicated by the radial arrows 28a and 28b. The edge parts 32 and 33 are prestressed radially inward, for instance by spring elements (not shown).

Due to a radial movement by the edge parts 28a and 28b, the sawtooth-like structures arranged on the edge parts, with their projections VO, can move out of the undercuts HL, HN, HM (see also FIG. 3 and FIG. 3a) that are between the cylindrical facets 14l, 14n, 14m and that are impressed into the reflector 21 so that a movement column 36 results for the edge parts 32, 33. Once the radial displacement of the edge parts 32 and 33 has concluded, this movement gap 36 makes it possible for them to be moved in the axial direction of the arrow 27 out of the inside of the reflector 21 and releases the reflector 21. Thus the die 22 can be removed from the reflector 21 despite the radial undercuts HL, HM, HN on the reflector interior 30.

FIGS. 15c and 15d show another embodiment of an inventive tool 22, in a view approximately along the sectional line XVc-XVc in FIG. 15a. It is clear that this die 22 comprises five parts, in addition to the edge parts 32 and 33 and the center part 31 described in the foregoing, there being other edge parts 34 and 35. In this embodiment of a die 22, once the pressing process has concluded, first the center part 31 moves away from the viewer transverse to the view plane, starting from a position like FIG. 15c, so that then the edge parts 34 and 35 can move radially inward along the arrows 28c and 28d. Then the edge parts 32 and 33 described in the foregoing can move radially inward along the arrows 28a and 28b. The resulting movement space 36 then makes it possible for the entire die 22, the edge parts 32, 33, 34, and 35 and the center part 31, to move axially along the center longitudinal axis M so that the die 22 can be removed entirely from the inside the reflector 21.

The embodiment in FIG. 16 shows another inventive die 22 having three tool parts x, y, and z, each of which has a 120° angular extent. In this case, as well, the view is a top view, similar to the view in FIG. 15c, the reflector 21 not being shown in FIG. 16. FIG. 16 illustrates that only a circumferential angularly extending region z of the die is filled with concave cylindrical or concave spherical or generally inverted facets IF for producing cylindrical or spherical or nonspherical, undercut facets on the corresponding interior 30 of the reflector 21. The other die parts x and y are mainly continuously smooth, i.e. free of bumps or depressions.

Radial movement by the die parts must be possible in order to be able to produce undercut facets 14 on the interior 30 of the reflector 21 by means of the tool part z. Comparing FIGS. 16 and 18, this can happen for instance in that the tool part z executes a radial movement relative to the fixed tool parts x and y along the radial arrow 28e. While FIG. 16 shows e.g. the position of the die 22 that the die assumes during the pressing process, FIG. 18 illustrates the radially inserted position of the die part z after performing a pressing process for removing the die from the reflector 21 that has been formed.

In an alternative embodiment like FIG. 17, the three tool parts x, y, and z move radially outward so that they are spaced apart, as indicated by the double arrows. During the pressing process, the tool parts x, y, and z of the die 22 are in the withdrawn position like FIG. 17, so that the gaps indicated by the double arrows are not closed by a closure part or a plurality of closure parts (not shown) so that these gaps are not pressed onto the interior 30 of the reflector 21. These closure parts can be for instance axially displaceable and, similar to how this is provided in the embodiments in FIGS. 15a and 15b, can be provided with conical exterior surfaces. For the purpose of removing the die, starting from a position like FIG. 17, after the closure parts have executed an axial movement, a radial insertion movement for the three parts x, y, and z can be initiated so that a position like FIG. 16 is attained in which the die 22 can be removed from the reflector 21.

In another embodiment of a die 22 in FIG. 19, it is indicated that the displaceable parts 32, 33 of the die 22 can also perform a pivot movement about a pivot axis 37 located in the region of the foot of the die 22. In an alternative embodiment of the die 22 like FIG. 20, the pivot axis 37 is provided in the head region of the two edge parts 32 and 33. The embodiments in FIGS. 19 and 20 demonstrate that a radial movement by parts 32, 33, 34, and 35 of a die 22 can also be provided by a pivot movement. In this case, as well, however, closure parts or spacers (not shown) must be provided that prevent a radial movement during the pressing process.

FIGS. 19 and 20 indicate that, for obtaining undercut facets 14 on the interior 30 of the reflector 21, a corresponding external shape 29 of the die 22 can also be provided along only a partial region of the external shape 29 of the die 22, only those parts or segments of the multi-part die 22 that are provided for generating undercut facets 14 having to be radially displaced.

In contrast, the embodiments in FIGS. 15a through 15d, indicate that projections Vo or inverted facets IF that can produce undercut facets on the interior 30 of the reflector 21 can also be provided along the entire outside face 29 of the die 22.

The embodiment in FIGS. 15a through 22 illustrates all of the dies 22 that can be used when pressing a reflector for attaining undercut segments. Depending on which shape the undercut segments or the undercuts have, the outside surface 29 of the die 22 must be correspondingly shaped like a male die with a geometrically inverted shape.

With the exception of the embodiment in FIG. 3a, the foregoing description of the figures described primarily embodiments of inventive light fixtures, reflectors, and dies that relate to segments with a cylindrical basic shape. However, the inventive teaching includes the arrangement of undercuts between or adjacent desired shaped segments. Thus the basic shapes of the segments can change for instance along a column or along the circumferential direction of the reflector so that for instance alternating cylindrical and spherical segments are arranged in the direction along a column or for instance alternating cylindrical or spherical segments are also arranged angularly. In addition, inventive undercuts or dead spaces can be located between adjacent segments, one of the segments having an inwardly curved reflecting surface and the adjacently arranged segment spaced apart by the undercut having a smooth surface.

Finally, the radial depth of the undercuts, that is the size of the overlap U, can vary along a column and/or along the circumferential direction of the reflector.

Moreover, the geometrical shape of the undercuts can also vary along a column and/or along a row of the segments.

Finally, the height of the undercuts, that is, the axial extension of each undercut along the center longitudinal axis M of the undercuts, can also vary along a column and/or along a row of facets.

1. A light fixture for illuminating building surfaces or portions thereof or exterior surfaces, the fixture including a mainly cup-shaped curved reflector centered on a longitudinal axis and having an interior adapted to hold a light source and formed with a plurality of facet-like segments at least some of which have a radially inwardly curved surface and at least some of which are formed with radially extending undercuts.

2. The light fixture in accordance with claim 1 wherein the segments each have a reflecting surface with a cylindrical or spherical or nonspherical shape.

3. The light fixture in accordance with claim 1 wherein a plurality of segments is arranged between an apex and a free edge of the reflector.

4. The light fixture in accordance with claim 1 wherein the segments are cylindrical and centered on respective cylinder axes each oriented at an acute angle to the enter longitudinal axis of the reflector, the acute angles varying as a distance from the segment to the apex changes.

5. The light fixture in accordance with claim 4 wherein a tangent on an exterior of the reflector in each connecting region of a cylindrical segment forms an angle of deviation with the cylinder axis of the respective segment.

6. The light fixture in accordance with claim 5 wherein each angle of deviation varies with a distance between the respective segment and the apex.

7. The light fixture in accordance with claim 1 wherein the light source is a point source.

8. The light fixture in accordance with claim 1 wherein the light source is a halogen lamp, or at least one LED.

9. The light fixture in accordance with claim 1 wherein the light source is arranged near or at a focal point of the reflector.

10. The light fixture in accordance with claim 1 wherein the reflector has a generally parabolic cross-section.

11. The light fixture in accordance with claim 1 wherein the reflector is mainly rotationally symmetrical about its center longitudinal axis.

12. The light fixture in accordance with claim 1 wherein the reflector has a generally circular light outlet aperture.

13. The light fixture in accordance with claim 1 wherein the segments are arrayed in rows extending angularly of the longitudinal axis, curvature radii of the segments varying along at least some of the rows.

14. The light fixture in accordance with claim 13 wherein the light fixture produces a generally oval illumination intensity distribution.

15. The light fixture in accordance with claim 1 wherein the light fixture is arranged immediately on a ceiling of a building room and is shaped as a downlight.

16. The light fixture in accordance with claim 1 wherein the light fixture is arranged indirectly on a ceiling of a building room via conductor rails and is a spotlight.

17. The light fixture in accordance with claim 1 wherein the light fixture illuminates regions of a side wall and regions of a floor of a room.

18. The light fixture in accordance with claim 17 wherein the light fixture illuminates regions of the side wall uniformly.

19. The light fixture in accordance with claim 1 wherein the light fixture is shaped as a pole-mounted light fixture.

20. The light fixture in accordance with claim 1 wherein the segments are arrayed in rows extending angularly of the longitudinal axis, curvature radii of the segments being constant along at least some of the rows.

21. The light fixture in accordance with claim 20 wherein the light fixture produces a uniform illumination intensity distribution within a circular field of light.

22. The light fixture in accordance with claim 1 wherein the segments are arrayed in columns extending generally from the apex to a free outer edge of the reflector, curvature radii of the segments varying along at least some of the columns.

23. The light fixture in accordance with claim 1 wherein the segments are arrayed in columns extending generally from the apex to a free outer edge of the reflector, curvature radii of the segments being constant along at least some of the columns.

24. The light fixture in accordance with claim 1 wherein the segments extend only in one or a plurality of partial regions of an inner surface of the reflector.

25. The light fixture in accordance with claim 24 wherein the partial region is circumferentially limited.

26. The light fixture in accordance with claim 24 wherein other regions of the inner surface of the reflector are mainly smooth.

27. The light fixture in accordance with claim 24 wherein other regions of the inner surface of the reflector are filled with segments having surfaces that are spherically or nonspherically curved toward the inside or are filled by flat segments.

28. The light fixture in accordance with claim 1 wherein the segments cover substantially the entire inner surface of the reflector.

29. The light fixture in accordance with claim 6 wherein the angle of deviations vary such that segments near a free edge of the reflector have larger angles of deviation than segments near the apex of the reflector.

30. The light fixture in accordance with claim 1 wherein the segments are arranged along annular rows that run angularly of the axis and along radial columns that extend from the apex to a free edge of the reflector.

31. The light fixture in accordance with claim 1 wherein two spaced-apart rows of segments have a circumferential angle offset.

32. The light fixture in accordance with claim 1 wherein one of the undercuts is arranged between every two segments arranged adjacent each other in the direction of the center longitudinal axis.

33. The light fixture in accordance with claim 1 wherein the reflector element is made of aluminum.

34. The light fixture in accordance with claim 33 wherein the reflector element is pressed aluminum.

35. A method for producing a reflector element from a starting material workpiece and having a plurality of segments on the interior, characterized by the following steps:
providing a starting material workpiece;
exerting a relative force between the workpiece and a male die, the male die having radial projections for producing undercuts between adjacent segments in the workpiece;
performing a radial movement of sections or parts of the male die relative to the reflector element shaped from the workpiece so that the projections are moved out of the undercuts; and
performing an axial movement of the male die relative to the reflector element for removing the male die from the reflector element.

36. A tool for producing a mainly cup-shaped and curved reflector element that is filled on its interior with undercut segments, using a metal shaping method, including a shaping surface that functions as a male die during the shaping process and is filled with radial projections for attaining undercuts on the reflector, the tool including at least one displaceable section or part that is radially displaceable relative to at least one other section or part, so that during the shaping process a mainly continuous shaping surface is provided, and as a result of a radially inward displacement movement by the displaceable part or section the projections can be moved radially out of the undercuts.
